(19) United States
(12) Patent Application Publication
(10) Pub. No.: US 2008/0244081 A1
(43) Pub. Date: Oct. 2, 2008

(54) Automated testing of audio and multimedia over remote desktop protocol

(75) Inventors: Thirunavukkarasu Elangovan, Redmond, WA (US); Somesh Goel, Newcastle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/731,221

(22) Filed: Mar. 30, 2007

(51) Int. Cl. G06F 15/16

(52) U.S. Cl. 709/231

(57) ABSTRACT

A framework for automated testing of audio and/or multimedia rendering capabilities in a terminal services environment is provided in which a terminal server is arranged with a media player that is controllable by a client to playback one or more of a variety of pieces of media content over a terminal service protocol. At the client, a recorder makes a recording of the remotely played audio/multimedia content which is compared using a fuzzy verifier against the original content. The fuzzy verifier is arranged to take into account variations in the fidelity of the recorded content that may occur as a result of the network type (e.g., broadband vs. dial-up), network conditions, and data compression when making an assessment to thereby increase the accuracy and reliability of the audio and multimedia testing and eliminate the need for subjective analysis.

### BACKGROUND

Testing is often a critical component of successful product development, including products implemented using software. Thoroughly tested products that meet the functional, performance, and usability expectations of customers generally stand the best chance of gaining a satisfied base of customers and a good market position. Developers who utilize well designed and implemented product testing plans can typically avoid quality failures and usability gaps in the end product.

Product developers often utilize product testing to identify defects early in the product development cycle in order to reduce overall costs. Testing also can be used to push a product to its design limits in order to optimize or verify key performance factors such as response time, glitches (i.e., disruption in the provision of a feature or service), operating speeds, reliability, and extensibility/scalability.

To provide the most reliable and cost-effective results, product testing should generally be performed using repeatable methodologies that produce objective data. Unfortunately, current testing methodologies of audio and multimedia (e.g., video) rendering in a terminal services environment (i.e., one in which an application running on a server is accessed remotely from a client computer using a protocol) typically involves testing personnel consuming audio and/or video while seated at the client computer. Aside from being labor-intensive, such testing techniques are not adequately reproducible and are inherently subjective. In addition, testing personnel are generally unable to differentiate between content rendering problems that are caused due to design issues in components (e.g., the application or protocol) in the terminal services environment, and those which are caused due to conditions in the environment such as bandwidth availability or network congestion. For example, servers commonly employ differing amounts of data compression and/or packet flow control in response to network conditions which results in reduced fidelity of the audio or multimedia to be rendered at the client. Human testers are typically unable to take these variations into account when evaluating the quality of the received audio or multimedia when played at the client.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A framework for automated testing of audio and/or multimedia rendering capabilities in a terminal services environment is provided in which a terminal server is arranged with a media player that is controllable by a client to playback one or more of a variety of pieces of media content (i.e., audio or multimedia) over a terminal service protocol. At the client, a recorder makes a recording of the remotely rendered media content which is compared using a fuzzy verifier against the original content. The fuzzy verifier is arranged to take into account variations in the fidelity of the recorded content that may occur as a result of the network type (e.g., broadband vs. dial-up), network conditions, and data compression when making an assessment to thereby increase the accuracy and reliability of the audio and multimedia testing and eliminate the need for subjective analysis.

In various illustrative examples, the media player is arranged using a DCOM (Distributed Component Object Model) server that provides Microsoft Windows® ActiveX playback controls on a remote basis to a controller at the client. The client records the media content that is remotely rendered over an RDP (Remote Desktop Protocol) terminal service session by directly plugging in to an RDP client or by using a software loopback provided by a Windows API (Application Programming Interface). A fuzzy verifier compares differences between the recorded content and the original against one or more predefined criteria to make an objective determination of the acceptability of the recorded content. An analyzer provides objective data associated with the media content such as signal-to noise ratio or other fidelity metrics.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 is a diagram of an illustrative environment 100 supporting a terminal services session between a terminal server and a client computer;

FIG. 2 shows details of an illustrative basic RDP architecture;

FIG. 3 shows an illustrative remote audio and multimedia testing framework which utilizes a server for automated playback of media content and a testing client that records the playback and compares the recording with the original; and

FIG. 4 shows an illustrative class diagram which depicts details of server-side and client-side components which support the present remote audio and multimedia testing framework.

### DETAILED DESCRIPTION

Terminal services provide functionality similar to a terminal-based, centralized host, or mainframe environment in which multiple terminals connect to a host computer. Each terminal provides a conduit for input and output between a user and the host computer. A user can log on at a terminal, and then run applications on the host computer, accessing files, databases, network resources, and so on. Each terminal session is independent, with the host operating system managing multiple users contending for shared resources.

The primary difference between terminal services and a traditional mainframe environment is that the terminals in a mainframe environment only provide character-based input and output. A remote desktop client or emulator provides a complete graphical user interface, including, for example, a Microsoft Windows® operating system desktop and support for a variety of input devices, such as a keyboard and mouse.

In the terminal services environment, an application runs entirely on the terminal server. The remote desktop client performs no local execution of application software. The server transmits the graphical user interface and sound to the client. The client transmits the user's input back to the server.

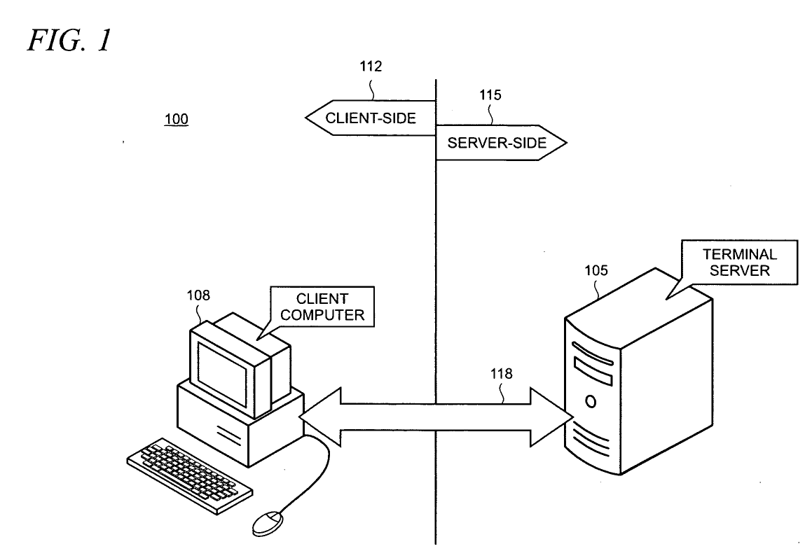

Turning now to the figures where like reference numerals indicate like elements, FIG. 1 is a diagram of an illustrative environment 100 supporting a terminal services session between a terminal server 105 and a client computer 108. Environment 100 is divided into a client-side and a server-side, as indicated by reference numerals 112 and 115, respectively. Terminal server 105 on the server-side 115 operatively communicates with the client computer 108 on the client-side 112 over a network 118 using a terminal services protocol. In this illustrative example, the terminal services protocol is arranged to use a Remote Desktop Protocol (“RDP”) that typically operates over a TCP/IP (Transmission Control Protocol/Internet Protocol) connection between the client computer 108 and terminal server 105 on network 118.

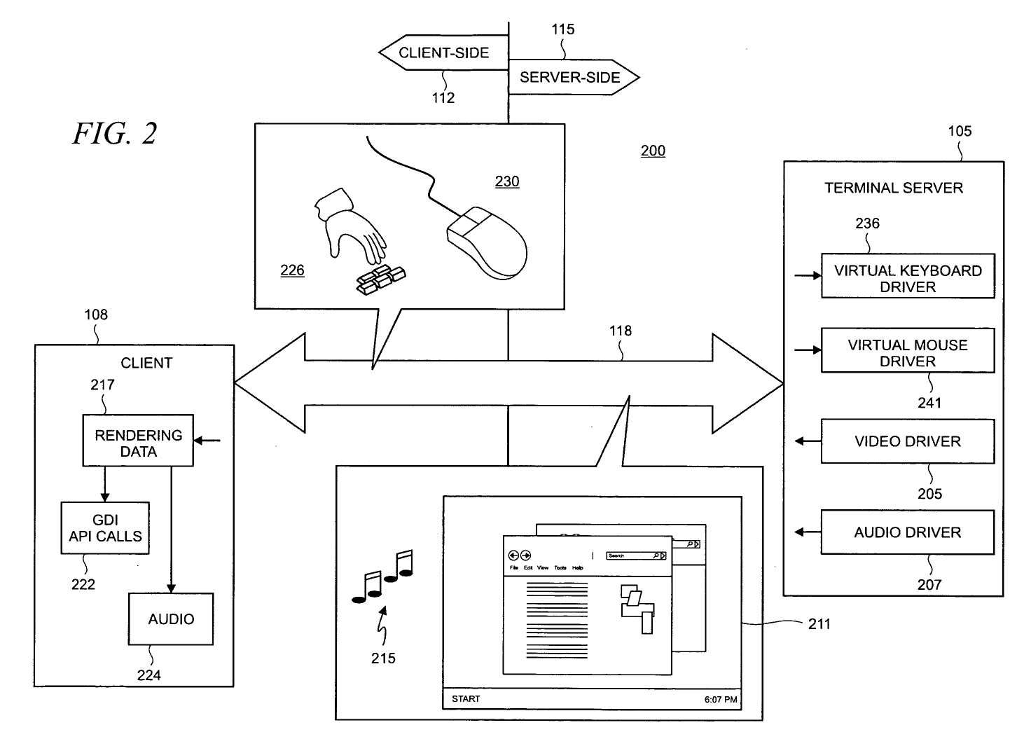

FIG. 2 shows details of a basic RDP architecture 200. On the server side 115, an RDP video driver 205 renders display output 211 by constructing the rendering information into network packets using the RDP protocol and sending them over the network 118 to the client 108. An audio driver 207 generates a packetized audio stream 215 on the RDP protocol. RDP data is typically encrypted, generally in a bi-directional manner, although in some cases only data from the client 108 to the terminal server 105 is encrypted. Such encryption is utilized to prevent discovery of user's passwords and other sensitive information by “sniffing” the wire.

On the client-side 112, rendering data 217 (which may include graphics and/or audio) is interpreted by the client 108 into corresponding GDI (Graphics Device Interface) API calls 222. An audio decoder (not shown) decodes rendering data 217 into audio 224. On an input path, client keyboard and mouse messages, 226 and 230 respectively, are redirected from the client 108 to the terminal server 105. On the server-side 115, the RDP architecture 200 utilizes its own virtual keyboard 236 and mouse driver 241 to receive and interpret these keyboard and mouse events.

In addition to the RDP components shown in FIG. 2, RDP architecture 200 typically utilizes one or more of a variety of mechanisms to optimize bandwidth usage over the network 118. For example, data compression and caching of bitmaps and glyphs is commonly used to improve performance, particularly over low bandwidth connections with applications that make extensive use of large bitmaps. The RDP architecture 200 is also further arranged to implement flow control at the TCP/IP layer as congestion on network 118 is experienced. The number of packets that need to be transmitted (i.e., because they are not acknowledged as being received at the client) is a typical measure of network congestion or impairment. In some implementations, a prioritization methodology is utilized in response to network conditions so that, for example, graphics are rendered smoothly and glitch free while audio is rendered as bandwidth becomes available on the network 118.

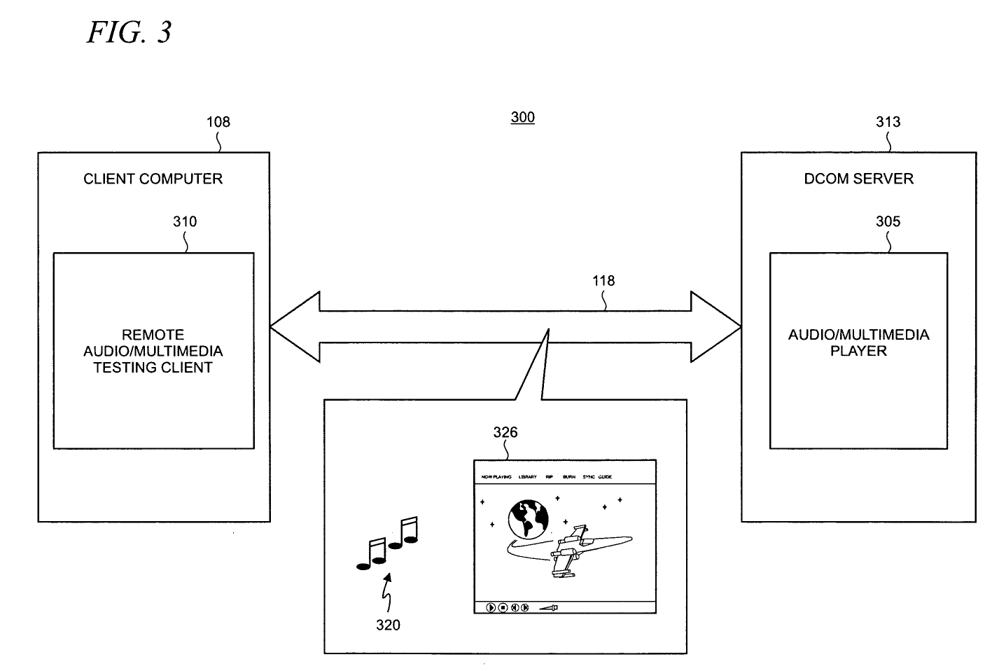

FIG. 3 shows an illustrative remote audio and multimedia testing framework 300 which utilizes a media player 305 for automated playback of media content that is coupled over the RDP protocol 118 to a remote audio and multimedia testing client 310 running on a client computer 108. The testing client 310 records the playback and compares the recording with original content. In this illustrative example, the media player 305 is implemented using a DCOM server 313 that supports the remoting of objects associated with the media player 305 such as ActiveX controls to the testing client 310.

The testing client 310 interacts with the controls provided by the DCOM server 313 to control the media player 305 in playing various types of audio and multimedia, respectively indicated by numerals 320 and 326 in FIG. 3. Audio 320 may comprise music, voice, soundtracks, etc., and is typically encoded prior to transport over the RDP protocol 118. Any of the variety of conventional protocols may be supported including, for example, MP3 (Moving Pictures Expert Group, MPEG-1, audio layer 3), WMA (Windows Media Audio) and MPEG-4 AAC (Advanced Audio Coding) for audio media content. Multimedia 326 may comprise video (and associated audio), interactive content using text, graphics, animation, images, and/or sound, or some combinations thereof. As with audio 320, the multimedia content 326 is typically encoded. Popular encoding formats include WMV (Windows Media Video), VC-1 (also known as the Society of Motion Picture and Television Engineers, SMPTE 421M), MPEG-1, MPEG-2, MPEG-4 (also known as International Telecommunications Union ITU-T H.264), Apple QuickTime, Motion-JPEG (Joint Photographic Experts Group), and RealMedia.

In most applications of the present automated testing, the particular segments or samples of audio and/or multimedia content are selected in order to test particular operating or design parameters in a terminal services environment. The segments may be arranged into individual scenarios that reflect specific user patterns, test cases, or best/worst cases in order to provide repeatable tests as may be required for design optimization, fault localization or sensitivity testing.

Encoding of the audio 320 and multimedia 326 is typically performed to reduce the bandwidth necessary to transport the content between a terminal server and client by using lossy data compression techniques that significantly reduce the file size of the audio or multimedia content without a significant loss in perceptible quality. The encoded content is then decoded and rendered at the client. Encoding and decoding is typically performed using a combined decoder/encoder device called a codec (not shown in FIG. 3).

In many RDP applications, the compression depth applied can vary according to available bandwidth. That is, higher rates of compression with greater data loss are utilized when bandwidth is limited and lower rates of compression are used when bandwidth is more plentiful. Bandwidth availability is generally based on network type (i.e., high bandwidth local area network or broadband network as compared with a low bandwidth dial up connection) and network condition (i.e., network loading, congestion, etc.). Thus, the fidelity of the signals is reduced through application of greater compression depth in low bandwidth networks so that content playback is smooth and glitch free, albeit with lower quality.

The testing client 310 records the remotely supplied media content over the network 118 using either a software-enabled loopback, or via a direct plug-in connection into an RDP client. The recorded media content is then analyzed by a fuzzy verifier in an automated manner which compares the recording against the original content to make an assessment of the received media content. The fuzzy verifier is provided with an identification of the particular type of compression or codec used and compression depth and may thus take this information into account when making the assessment. In addition, the fuzzy verifier is arranged to maintain an awareness of network type (e.g., broadband, dial-up) and conditions (e.g., congested, non-congested) which it also takes into account when making its assessment. For example, the server may provide TCP/IP retransmission rates or other data which describe the condition of network 118 to the fuzzy verifier in the testing client 310.

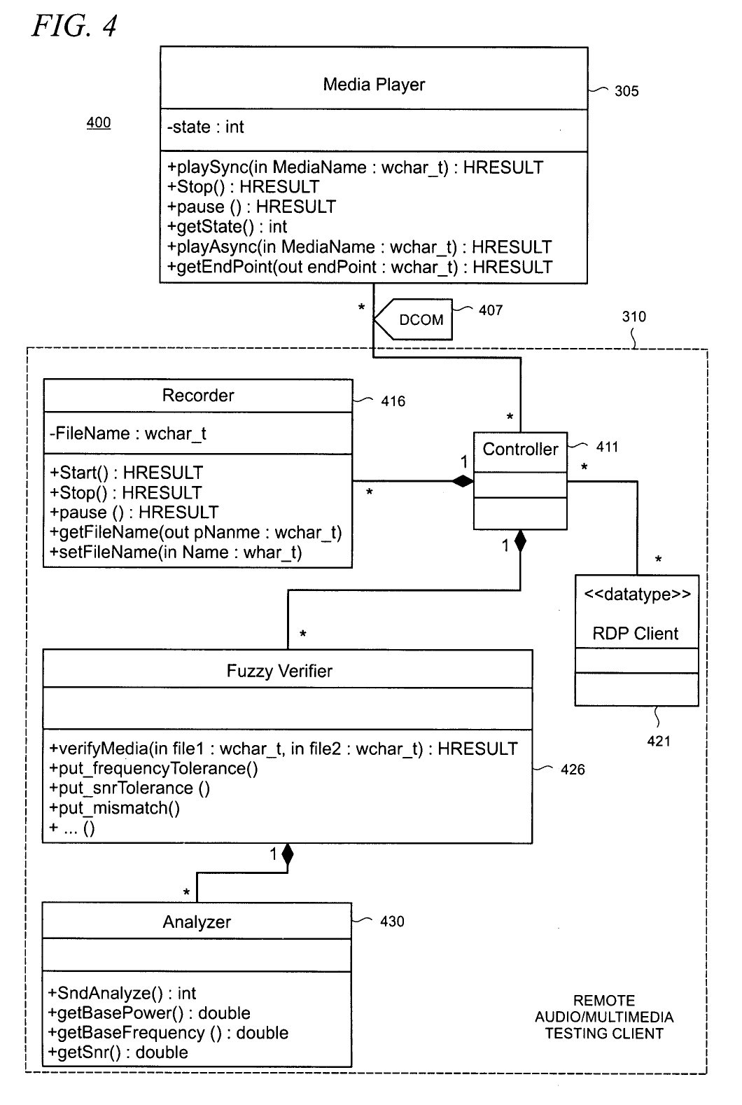

FIG. 4 shows an illustrative UML (Unified Modeling Language) class diagram 400 which depicts details of server-side and client-side components which support the present remote audio and multimedia testing framework. Utilizing a DCOM architecture 407, the media player 305 plays back a variety of different kinds of audio or multimedia content in a terminal services session that is arranged for testing a particular RDP architecture (e.g., RDP architecture 200 as shown in FIG. 2). Note that such content is provided in an original form on both the client and server sides.

A controller 411 in the testing client 310 uses the provided ActiveX controls (e.g., play, stop, pause, etc.) to control the playback in either synchronous or asynchronous modes. Controller 411 controls the playback in accordance with a test methodology that enables automated testing of the media content.

A recorder 416 records the remotely supplied media content. Recorder 416 is an abstract class which hides the internal implementation of concrete recorder classes (not shown). In this illustrative example, recorder 416 uses a software loopback functionality provided by a Microsoft Windows® API (e.g., an audio service API or a multimedia service API). Alternatively, recorder 416 is arranged for plugging in directly to the RDP client 421.

The fuzzy verifier 426 implements a comparison functionality to compare the recording of the media content playback received over RDP against the original samples. As noted above, the original samples are provided to components on both the client and server sides. The fuzzy verifier 426 applies one or more criteria, for example tolerances values for frequency or signal-to-noise ratio (“SNR”) or a mismatch in one or more parameters that represent fidelity or other attribute of merit, to the difference between the recording and original. The tolerances and mismatch values are set in accordance with the network conditions existing as the media player 305 renders the media content over the network 118 (FIG. 1), and also in view of the codec and/or compression depth associated with the content. Differences exceeding a defined parameter threshold are used as the basis of a particular quality assessment. For example, a piece of audio content defined by a particular number of digital samples might only match at rate of a 50% between the original content and the recording. However, given the network conditions and the expected rate of packets being dropped, this rate may be considered acceptable under certain circumstances. Thus, the fuzzy verifier 426 takes into account variations in the fidelity of the recorded content that occur as a result of network type and conditions and data compression to thereby increase the accuracy and reliability of the remote audio and multimedia testing.

An analyzer 430 is associated with the fuzzy verifier 426 to supply objective data associated with the recorded content. In this illustrative example, analyzer 430 is implemented as a wrapper that applies one or more analytical functions to the recorded media content and returns objective performance parameters. As shown, a number of illustrative parameters typically associated with audio or video are provided by the analyzer 430, including SNR, base power and base frequency. Other parameters or fidelity metrics of particular interest may also be utilized as required by a specific application of remote audio and multimedia testing. The analyzer 430 may also be arranged to provide objective data associated with the original content.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for testing media content rendering performance in a terminal services environment, the method comprising the steps of:
using a media player on a server side of the environment to play original media content, over a terminal services protocol, that is receivable by a client side of the environment;
recording at least a portion of the original media content played by the media player in order to generate recorded media content;
using an automated methodology for assessing media content rendering performance, the methodology i) comparing the recorded media content with the original media content, and ii) using data indicative of a condition of a network that is utilized to operatively couple the server side to the client side in the environment.

2. The method of claim 1 in which the automated methodology is further arranged for using data indicative of bandwidth optimization measures used in the environment, the measures including one of flow control or data compression.

3. The method of claim 1 in which the comparing includes identifying a difference between the recorded media content and the original media content and determining if the difference exceeds a performance threshold.

4. The method of claim 3 in which the threshold sets an acceptable number of dropped samples associated with the recorded media content.

5. The method of claim 1 in which the original media content is one of audio, video, or multimedia.

6. The method of claim 1 in which the methodology further includes remotely operating the media player over the network.

7. The method of claim 1 in which the terminal services protocol is RDP.

8. A computer-readable medium containing instructions which, when executed by a one or more processors disposed in an electronic device, implements an architecture that is operable on a client and arranged for remotely testing media content rendered during a terminal services session, the architecture comprising:
a controller arranged to remotely control a media player running on a server supporting the terminal services session, the media player rendering the media content responsively to the control;
a recorder for recording at least a portion of the media content played by the media player to create recorded media content; and
a fuzzy verifier arranged for comparing differences between the media content and the recorded media content against one or more performance thresholds.

9. The computer-readable medium of claim 8 in which the architecture further comprises an analyzer arranged for analyzing the media content or the recorded and returning performance data associated with i) the media content, or ii) the recorded media content.

10. The computer-readable medium of claim 9 in which the performance data comprises one of signal-to-noise ratio, base power, or base frequency.

11. The computer-readable medium of claim 8 in which the architecture further comprises an RDP client arranged for providing access for the recorder to the media content.

12. The computer-readable medium of claim 8 in which the performance thresholds are set in accordance with network conditions associated with the terminal services session.

13. The computer-readable medium of claim 8 in which the performance thresholds are set in accordance with a media content encoding type utilized by the media player.

14. A method of provisioning a terminal server with remote media content rendering testing functionality, the method comprising the steps of:
installing a media player on the terminal server, the media player utilizing a data compression algorithm for reducing bandwidth used for transporting media content rendered by the media player using a remote desktop protocol; and
providing a media player having capability for control by a remote client; and
operating the media player through control from the remote client in accordance with a test scenario, the test scenario i) defining a set of one or more audio or multimedia content samples to be rendered and, ii) being used by a fuzzy verifier at the remote client to assess quality of the rendered media content.

15. The method of claim 14 in which the media player is implemented using a DCOM server to support remote procedure calls from the remote client.

16. The method of claim 14 in which the capability for control is provided using an ActiveX control architecture.

17. The method of claim 14 including a further step of providing an identification of the data compression algorithm to the fuzzy verifier so that the fuzzy verifier may assess the quality of the rendered media content in view of the data compression algorithm.

18. The method of claim 14 in which the terminal provides data describing network conditions associated with the transporting of media content to the fuzzy verifier so that the fuzzy verifier assesses the quality of the rendered media content in view of the network conditions.

19. The method of claim 18 in which the data describing the network conditions comprises TCP/IP retransmission data.

20. The method of claim 14 in which the data compression algorithm conforms with one of MP3, MPEG-4 AAC, WMA, VC-1, WMV, MPEG-1, MPEG-2, MPEG-4, Motion-JPEG, Quicktime, or RealMedia.
